(19) United States
(12) Patent Application Publication
(10) Pub. No.: US 2024/0248832 A1
(43) Pub. Date: Jul. 25, 2024

(54) Resolving Software Errors

(71) Applicant: International Business Machines Corporation, Armonk, NY (US)

(72) Inventors: Jeremy R. Fox, Georgetown, TX (US); Jessica Nahulan, Markham (CA); Tiberiu Suto, Franklin, NY (US); Carolina Garcia Delgado, Zapopan (MX)

(21) Appl. No.: 18/158,189

(22) Filed: Jan. 23, 2023

(51) Int. Cl. G06F 11/36

(52) U.S. Cl. CPC G06F 11/3664

(57) ABSTRACT

Resolving software errors is provided. It is detected that an error has occurred. It is determined whether the error had previously occurred. In response to determining that the error had previously occurred, it is determined whether one or more solutions were found during a search that successfully fixed the error. In response to determining that one or more solutions were found during the search that successfully fixed the error, a list of solutions that successfully fixed the error is generated.

### BACKGROUND

### 1. Field

The disclosure relates generally to software errors and more specifically to automatically applying a selected solution to resolve an encountered software error corresponding to an application running on a computer system.

### 2. Description of the Related Art

Within the world of computer systems, it is common to experience a software error message pop-up or some other type of alert that impacts the use of that application. Software errors result in unexpected outcomes from applications running on computer systems or cause the applications to act in ways that were not intended. In other words, applications are not performing according to user expectations. Software errors can occur due to many different reasons, such as, for example, a fault in coding of the applications.

Contacting technical support regarding a software error can often consume a significant amount of time (e.g., hours) and have an impact on the productivity of the user waiting for a solution to fix or resolve the software error. Furthermore, an entity (e.g., software company, enterprise, business, or the like) providing the software application corresponding to the software error can also incur a negative impact by having to assign program developers to find a solution for the software error instead of working on new software applications and features.

### SUMMARY

According to one illustrative embodiment, a computer-implemented method for resolving software errors is provided. A computer detects that an error corresponding to an application running on the computer has occurred. The computer determines a system configuration of the computer at a time of the error. The computer determines whether the error had previously occurred on one of the computer or at least one other computing system having a similar system configuration as the system configuration of the computer at the time of the error. In response to the computer determining that the error had previously occurred on one of the computer or the at least one other computing system having the similar system configuration as the system configuration of the computer at the time of the error, the computer determines whether one or more solutions were found during a search that successfully fixed the error on one of the computer or the at least one other computing system having the similar system configuration as the system configuration of the computer at the time of the error. In response to the computer determining that one or more solutions were found during the search that successfully fixed the error on one of the computer or the at least one other computing system having the similar system configuration as the system configuration of the computer at the time of the error, the computer generates a list of solutions that successfully fixed the error corresponding to the application. According to other illustrative embodiments, a computer system and computer program product for resolving software errors are provided.

### BRIEF DESCRIPTION OF THE DRAWINGS

FIG. 1 is a pictorial representation of a computing environment in which illustrative embodiments may be implemented;

FIG. 2 is a diagram illustrating an example of an error resolution management system in accordance with an illustrative embodiment;

FIG. 3 is a diagram illustrating an example of a software error message pop-up in accordance with an illustrative embodiment;

FIG. 4 is a diagram illustrating an example of a displayed list of solutions in accordance with an illustrative embodiment; and

FIGS. 5A-5B are a flowchart illustrating a process for resolving software errors in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

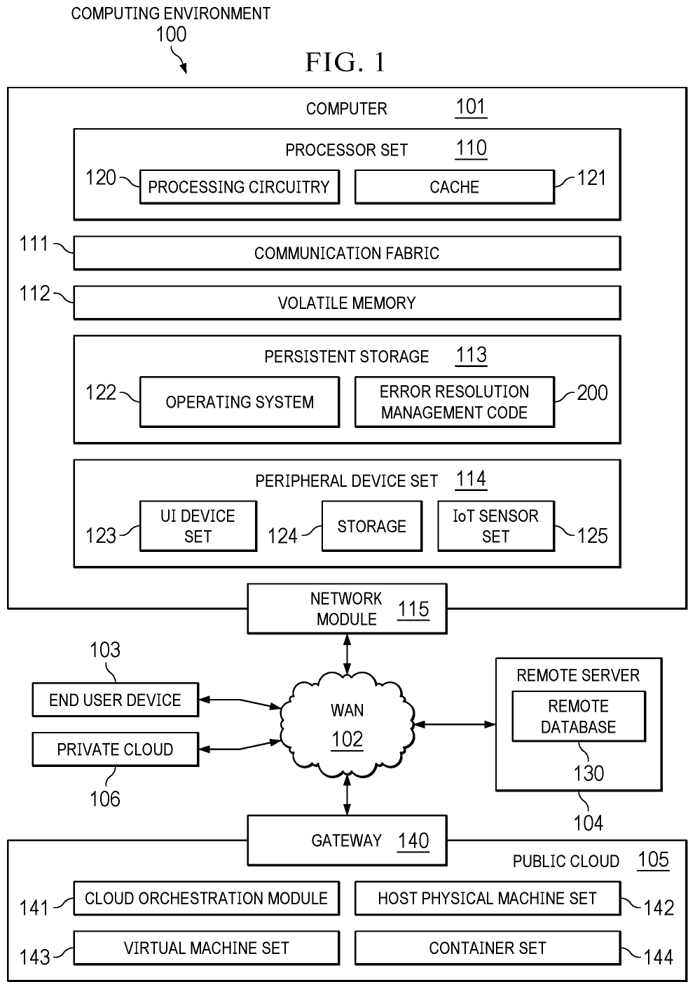

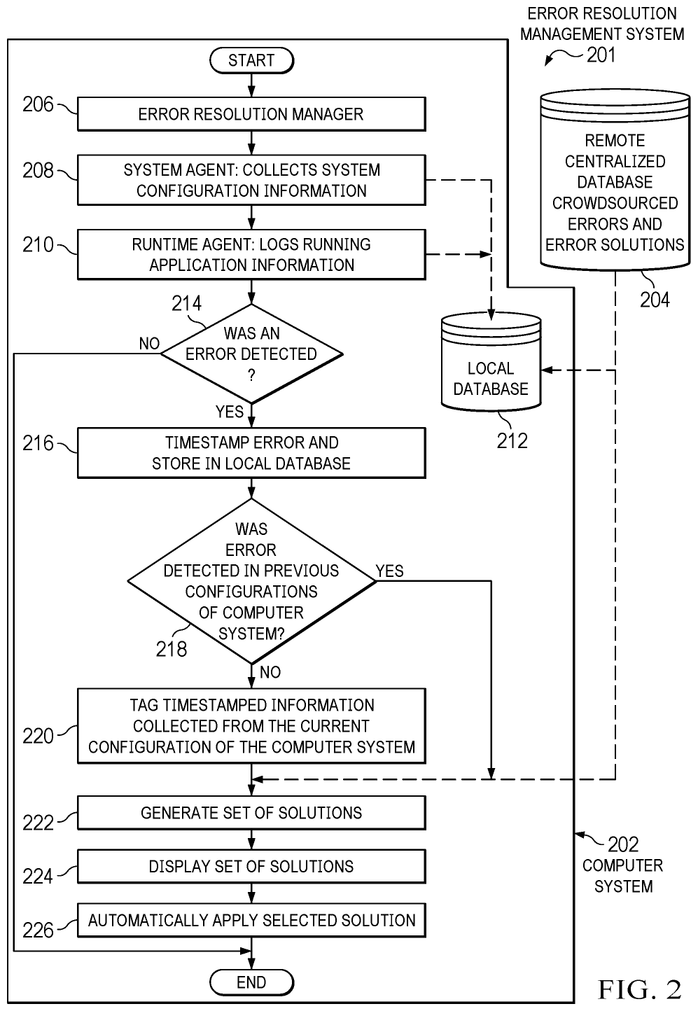

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as error resolution management code 200. For example, error resolution management code 200 utilizes local and crowdsourced information to determine a set of solutions having the greatest likelihood of fixing an encountered software error on computer 101. Further, error resolution management code 200 utilizes a system agent to identify the current configuration of computer 101 when the software error was encountered on computer 101. Furthermore, error resolution management code 200 utilizes a runtime agent to log runtime application information on computer 101 in order to determine a set of user interactions with the application that may have caused the software error. Error resolution management code 200 also enables the user to select the solution the user wants to apply to the application to fix the software error on computer 101. Error resolution management code 200 automatically applies the selected solution to the application to resolve the software error on computer 101. Moreover, error resolution management code 200 utilizes a feedback loop for better solution identification based on previous outcomes when applying solutions, whether successful or unsuccessful, when correlated to similarities in system configurations and application runtime interactions of other computing systems to the current user's system configuration and application runtime interactions. In addition, error resolution management code 200 can generate a “solution library” in a local database that error resolution management code 200 can access even when computer 101 is offline so that error resolution management code 200 can predict likely solutions to encountered software errors.

In addition to error resolution management code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and error resolution management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in error resolution management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The error resolution management code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (for example, a system administrator of an entity that operates computer 101), and may take any of the forms discussed above in connection with computer 101. EUD 103 typically receives helpful and useful data from the operations of computer 101. For example, in a hypothetical case where computer 101 is designed to provide an error resolution recommendation to an end user, this error resolution recommendation would typically be communicated from network module 115 of computer 101 through WAN 102 to EUD 103. In this way, EUD 103 can display, or otherwise present, the error resolution recommendation to the end user. In some embodiments, EUD 103 may be a client device, such as thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide an error resolution recommendation based on historical error resolution data, then this historical error resolution data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Illustrative embodiments automatically provide a user with a set of solutions (e.g., fixes, resolution action steps, repairs, or the like) that can potentially resolve an encountered software error on the user's computer system in less time than using the traditional channel of technical support. Illustrative embodiments can also search crowdsourced data stored on a secondary source of information, such as, for example, a remote centralized database connected to the Internet or other computer network, to obtain one or more solutions to the encountered software error. Further, illustrative embodiments can generate a score for respective solutions based on repetitive usage of each particular solution by other users that have experienced the same software error and the outcome of applying that particular solution to fix that same software error (e.g., successful fix or unsuccessful fix). Illustrative embodiments only select those solutions that have the greatest likelihood or probability of fixing the user's current software error based on identifying the degree of similarity between the configurations of other computer systems reporting successful fixes for that software error and the current configuration of the user's computer system when the software error was encountered.

As a result, illustrative embodiments can reduce costs incurred by companies that provide support for these software applications that are experiencing software errors. These supported software applications would also benefit from better user experiences (e.g., users not feeling abandoned after encountering a software error on their computer systems with no provided solutions). Illustrative embodiments can optionally be offered as a service for cloud hosted applications, where software companies can subscribe to the service. These subscribing software companies can receive software support and performance summaries regarding, for example, which software errors users search for solutions to most often, which solutions users typically utilize to resolve their software errors, which solutions actually resolve their software errors, which solutions do not resolve their software errors, and the like.

When a user encounters a software error corresponding to a particular software application running on the user's computer system, illustrative embodiments identify a set of solutions to resolve or fix the software error. For example, illustrative embodiments perform an autonomous search for solutions, which includes expected effectiveness of each respective solution in resolving the software error. When illustrative embodiments cannot identify any known solutions for that particular software error, illustrative embodiments can request other users to share solutions for that particular software error. For example, illustrative embodiments can offer and apply an online reward, such as, for example, points, stars, badges, increased online status or influence, or the like, to users who provide successful solutions to software errors that currently have no known solutions.

Thus, illustrative embodiments provide one or more technical solutions that overcome a technical problem with automatically managing resolution of encountered software errors on computer systems. As a result, these one or more technical solutions provide a technical effect and practical application in the field of software error resolution.

With reference now to FIG. 2, a diagram illustrating an example of an error resolution management system is depicted in accordance with an illustrative embodiment. Error resolution management system 201 may be implemented in a computing environment, such as computing environment 100 in FIG. 1. Error resolution management system 201 is a system of hardware and software components for automatically applying a selected solution to resolve an encountered software error on a computer system.

In this example, error resolution management system 201 includes computer system 202 and remote centralized database 204. Computer system 202 and remote centralized database 204 may be, for example, computer 101 and remote database 130 in FIG. 1. However, it should be noted that error resolution management system 201 is intended as an example only and not as a limitation on illustrative embodiments. For example, error resolution management system 201 can include any number of computer systems, remote databases, and other devices and components not shown.

In this example, computer system 202 includes error resolution manager 206, system agent 208, runtime agent 210, and local database 212. Error resolution manager 206 may be implemented in, for example, error resolution management code 200 in FIG. 1. Local database 212 may be implemented in, for example, storage 124 in FIG. 1.

A user of computer system 202 enables error resolution manager 206 to start the software error resolution processes of illustrative embodiments on computer system 202. For example, the user enables error resolution manager 206 to run in the background of an operating system loaded on computer system 202. The operating system may be, for example, operating system 122 in FIG. 1. In an alternative illustrative embodiment, error resolution manager 206 can run as an independent component of computer system 202. In yet another illustrative embodiment, error resolution manager 206 runs on an external computer system on the same network as computer system 202 or on a computing node in a cloud environment. In this latter alternative illustrative embodiment, the user can subscribe to the software error resolution services provided by error resolution manager 206.

Error resolution manager 206 utilizes system agent 208 to collect information regarding the current configuration of computer system 202 (e.g., processor type and speed, total and available memory, total and available storage, operating system and applications installed along with their current versions, and the like). System agent 208 runs once at each startup of computer system 202. Alternatively, system agent 208 only runs when a configuration change occurs on computer system 202 (e.g., a hardware change, software change, or the like).

In addition, error resolution manager 206 utilizes runtime agent 210 to generate a log of all running applications, the sequence in which applications were started and closed, currently open files along with their respective type and size, menu items selected by the user, messages or notifications issued by the operating system, and the like. Runtime agent 210 runs continuously during operation of computer system 202. Error resolution manager 206 may utilize the generated log to determine a set of interactions (e.g., user interactions with an application) that may have caused a software error.

As system agent 208 and runtime agent 210 collect the current system configuration information and system application runtime information, respectively, system agent 208 and runtime agent 210 timestamp the information and store this information in local database 212. At 214, error resolution manager 206 determines whether a software error was detected. At 216, in response to error resolution manager 206 receiving an indication that a software error was detected in a software application running on computer system 202, error resolution manager 206 timestamps the detected software error and stores the information regarding the detected software error in local database 212.

At 218, error resolution manager 206 performs an analysis of the information stored in local database 212 to determine whether this particular software error had been detected in one or more previous configurations (e.g., hardware/operating system/software configuration) of computer system 202. At 220, in response to error resolution manager 206 determining that this particular software error had been detected in one or more previous configurations of computer system 202 based on the analysis of the information stored in local database 212, error resolution manager 206 tags all of the timestamped information collected from the beginning of the current configuration of computer system 202 up to the time when this particular software error was detected as being potentially related to this particular software error.

In addition, error resolution manager 206 can optionally run all of the timestamped information that is potentially related to this particular software error through an information anonymizer process to anonymize all this information. Afterward, error resolution manager 206 can upload this anonymized information related to this particular software error to remote centralized database 204.

By analyzing the crowdsourced data uploaded by users to remote centralized database 204, error resolution manager 206 is able to determine patterns in versions of the application and steps taken by one or more users that resulted in the application generating the same error message pop-up on their computing systems. Error resolution manager 206 correlates all the versions of the application and the specific system configurations of the other computing systems with the current version of the application and the current system configuration of computer system 202 to identify potential solutions that have a high likelihood or probability of resolving the software error encountered by the user.

At 222, in response to error resolution manager 206 identifying potential solutions that have a high likelihood or probability of resolving the software error encountered by the user, error resolution manager 206 generates a set of solutions to resolve the software error. Further, error resolution manager 206 can rank the set of solutions from highest-ranked solution to lowest-ranked solution. Furthermore, error resolution manager 206 can package each respective solution in the set as a script or macro.

At 224, error resolution manager 206 displays the set of solutions to the user via a display device on computer system 202. Upon reviewing the displayed set of solutions, the user can select a solution from the set. Alternatively, error resolution manager 206 can automatically select the highest-ranking solution in the set. At 226, error resolution manager 206 automatically applies the selected solution to the application on computer system 202.

In instances where no known solution currently exists in the local database or the remote centralized database and a multitude of users have reported the same software error, error resolution manager 206 can incentivize other users, who encountered that same software error and were able to discover a solution, to share the discovered solution to the software error by providing an online reward to these other users. For example, error resolution manager 206 can post an online offer of a reward to anyone who discovers and uploads a solution for that particular software error. The reward may be, for example, an increased online influencer status as a provider of software error resolutions. Alternatively, the reward may be, for example, a star, a badge, an increased rating, or the like posted on a social media website corresponding to the user who discovered the solution. In some illustrative embodiments, error resolution manager 206 can place the reward on hold for a defined time period, such as, for example, 24 hours or any other time period, and only apply the reward in response to the software error message pop-up not recurring for that defined amount of time.

Error resolution manager 206 can also enable knowledgeable users (e.g., software error resolution experts) to contribute better solutions, which these knowledgeable users may have discovered, as compared to current solutions stored in local database 212 and remote centralized database 204. After vetting a particular solution corresponding to a given software error, error resolution manager 206 can add that particular solution to local database 212 and remote centralized database 204 as a fix to that software error. Error resolution manager 206 can also reward these knowledgeable users for providing better solutions.

It should be noted that there may be times when error resolution manager 206 may provide a solution that does not work for computer system 202. If a cost is associated with a provided solution that did not work, then error resolution manager 206 can prevent the user from paying for any solution that did not work and allow other solutions to be uploaded, which are related to that same software error, depending on which solutions may have worked to resolve that same software error for other users.

Error resolution manager 206 stores information regarding encountered errors corresponding to applications used on computer system 202 and their respective solutions in local database 212 in order for error resolution manager 206 to quickly resolve encountered software errors even when computer system 202 is offline. Error resolution manager 206 can store this information in a solution library of local database 212 for faster error identification and resolution.

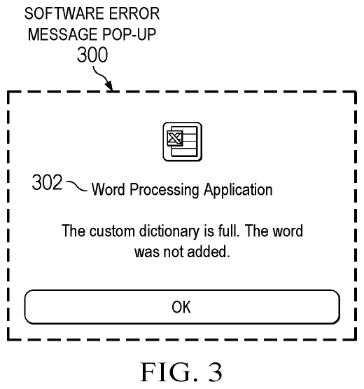

With reference now to FIG. 3, a diagram illustrating an example of a software error message pop-up is depicted in accordance with an illustrative embodiment. In this example, a user is utilizing word processing application 302 to draft a document on the user's computer system. The user's computer system may be, for example, computer system 202 in FIG. 2. While drafting the document, the user encounters a new software error that the user has not encountered before while utilizing word processing application 302.

In this example, software error message pop-up 300 states, “The custom dictionary is full. The word was not added.” Software error message pop-up 300 does not provide the user with any possible solutions to resolve the encountered software error.

Running in the background of the operating system of the user's computer system, an error resolution manager, such as, for example, error resolution manager 206 in FIG. 2, autonomously performs a search of at least one of a local database and a remote database, each containing a collection of software errors, their known solutions, and their correlation to the configuration of the user's computer system and a set of user interactions that led to the software error. The local database and the remote database may be, for example, local database 212 and remote centralized database 204 in FIG. 2.

The error resolution manager of illustrative embodiments generates a list of solutions and ranks (e.g., prioritizes) the solutions in the list based on historical past usage and outcome of each respective solution with regard to that particular software error. The error resolution manager can limit the number of solutions in the list to a predetermined number of highest-ranking solutions (e.g., 2, 3, 4, 5, or the like). The error resolution manager outputs (e.g., displays) the list of highest-ranked solutions to the user.

After reviewing the list of highest-ranked solutions, which have the highest probability of fixing the software error when applied to word processing application 302 on the user's computer system, the user selects a solution from the list. In response to receiving the user's selection (e.g., the first solution at the top of the list), the error resolution manager automatically applies the selected solution to the user's computer system. However, sometime later, software error message pop-up 300 appears again on the user's computer system. In response to the error resolution manager receiving an indication that software error message pop-up 300 appeared again on the user's computer system, the error resolution manager requests the user to make a different selection of another solution from the list of highest-ranked solutions. In response to receiving another selection from the list by the user, the error resolution manager automatically applies the newly selected solution to word processing application 302 on the user's computer system.

Afterward, it appears that the newly applied solution to word processing application 302 has resolved the software error corresponding to software error message pop-up 300 encountered by the user. Subsequently, the user finishes drafting the document on the user's computer system using word processing application 302.

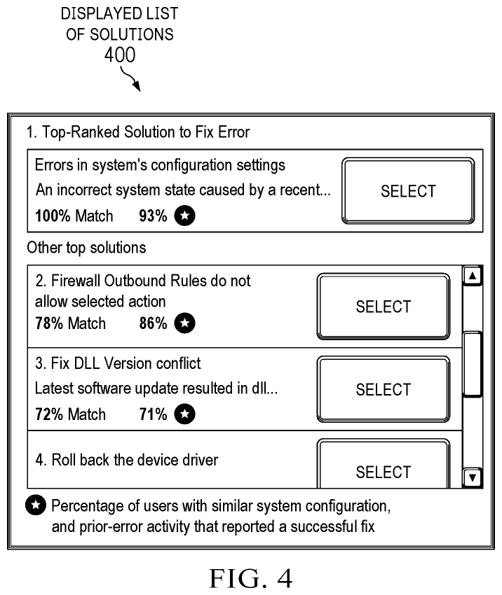

With reference now to FIG. 4, a diagram illustrating an example of a displayed list of solutions is depicted in accordance with an illustrative embodiment. An error resolution manager, such as, for example, error resolution manager 206 in FIG. 2, generates displayed list of solutions 400. Displayed list of solutions 400 corresponds to a particular software error that a user has encountered on the user's computer system, such as, for example, computer system 202 in FIG. 2.

In this example, displayed list of solutions 400 includes 4 solutions, which are numbered 1 through 4, that correspond to the encountered software error. The first solution in the displayed list is the top-ranked or highest-ranked solution having the greatest likelihood of fixing the encountered software error. The fourth solution in the displayed list is the bottom-ranked or lowest-ranked solution having the least likelihood of fixing the encountered software error.

In addition, displayed list of solutions 400 includes with each respective solution a percentage of users with same or similar system configuration and prior software error activity that reported a successful fix to that same software error. Displayed list of solutions 400 also includes with each respective solution a “Select” button. A user utilizes the Select button to select which solution in the displayed list that the user wants to apply to the application corresponding to the encountered software error. In response to receiving a selection of a particular solution, the error resolution manager automatically applies that particular solution to the application on the user's computer system.

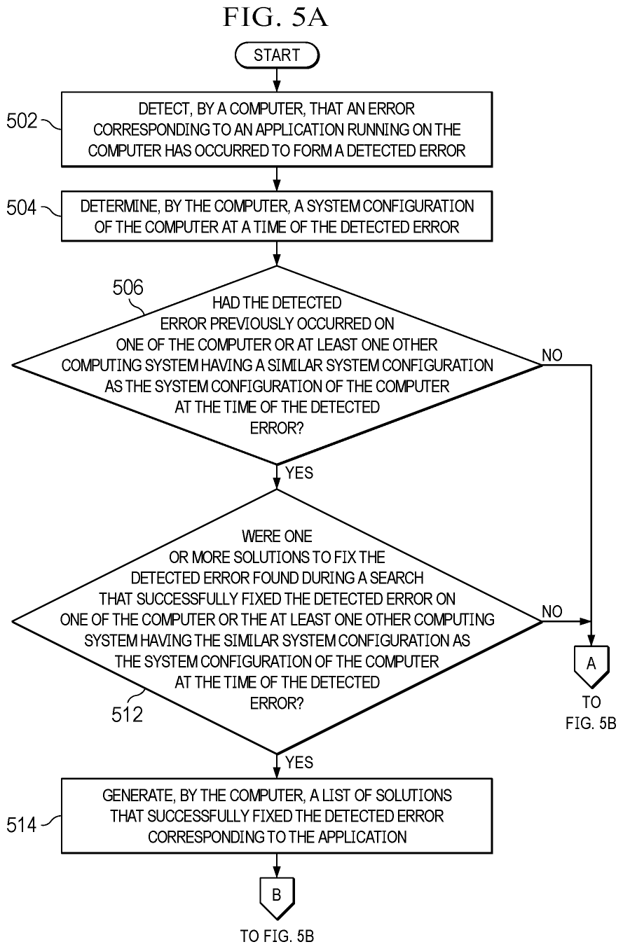

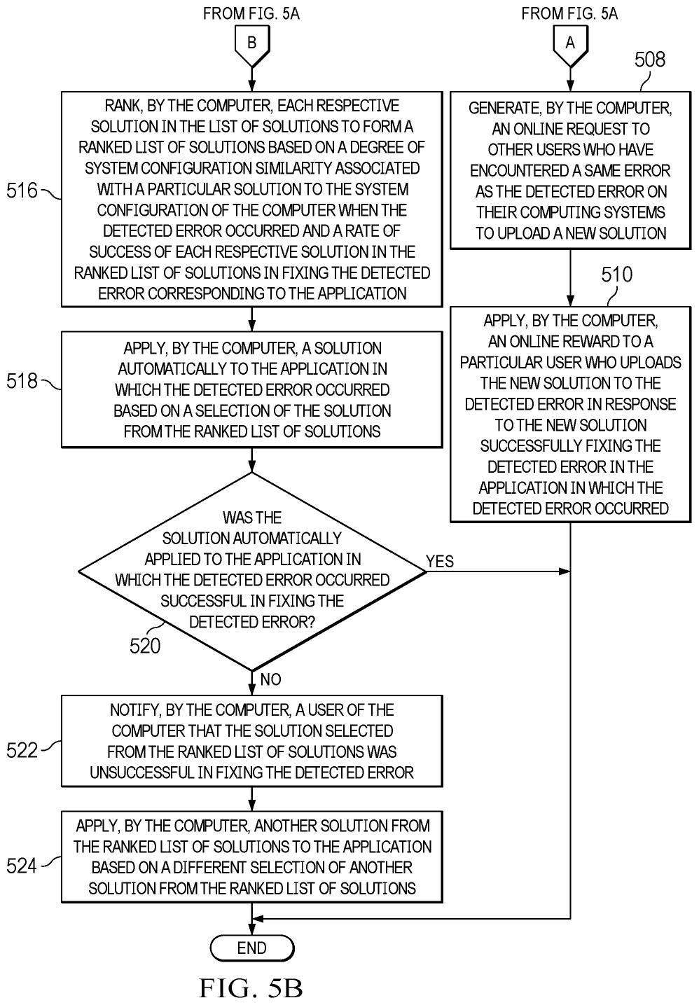

With reference now to FIGS. 5A-5B, a flowchart illustrating a process for resolving software errors is shown in accordance with an illustrative embodiment. The process shown in FIGS. 5A-5B may be implemented in a computer, such as, for example, computer 101 in FIG. 1 or computer system 202 in FIG. 2. For example, the process shown in FIGS. 5A-5B may be implemented in error resolution management code 200 in FIG. 1 or error resolution manager 206 in FIG. 2.

The process begins when the computer detects that an error corresponding to an application running on the computer has occurred to form a detected error (step 502). The computer determines a system configuration of the computer at a time of the detected error (step 504). The computer makes a determination as to whether the detected error had previously occurred on one of the computer or at least one other computing system having a similar system configuration as the system configuration of the computer at the time of the detected error (step 506).

If the computer determines that the detected error had not previously occurred on one of the computer or at least one other computing system having a similar system configuration as the system configuration of the computer at the time of the detected error, no output of step 506, then the computer generates an online request to other users who have encountered a same error as the detected error on their computing systems to upload a new solution (step 508). In addition, the computer applies an online reward to a particular user who uploads the new solution to the detected error in response to the new solution successfully fixing the detected error in the application in which the detected error occurred (step 510). Thereafter, the process terminates.

Returning again to step 506, if the computer determines that the detected error had previously occurred on one of the computer or at least one other computing system having a same or similar system configuration as the system configuration of the computer at the time of the detected error, yes output of step 506, then the computer makes a determination as to whether one or more solutions to fix the detected error were found during a search that successfully fixed the detected error on one of the computer or the at least one other computing system having the same or similar system configuration as the system configuration of the computer at the time of the detected error (step 512). If the computer determines that one or more solutions to fix the detected error were not found during the search that successfully fixed the detected error on one of the computer or the at least one other computing system having the same or similar system configuration as the system configuration of the computer at the time of the detected error, no output of step 512, then the process returns to step 508 where the computer generates an online request to other users who have encountered the same error. If the computer determines that one or more solutions to fix the detected error were found during the search that successfully fixed the detected error on one of the computer or the at least one other computing system having the same or similar system configuration as the system configuration of the computer at the time of the detected error, yes output of step 512, then the computer generates a list of solutions that successfully fixed the detected error corresponding to the application (step 514).

The computer ranks each respective solution in the list of solutions to form a ranked list of solutions based on a degree of system configuration similarity associated with a particular solution to the system configuration of the computer when the detected error occurred and a rate of success of each respective solution in the ranked list of solutions in fixing the detected error corresponding to the application (step 516). The computer applies a solution automatically to the application in which the detected error occurred based on a selection of the solution from the ranked list of solutions (step 518).

The computer makes a determination as to whether the solution automatically applied to the application in which the detected error occurred was successful in fixing the detected error (step 520). If the computer determines that the solution automatically applied to the application in which the detected error occurred was successful in fixing the detected error, yes output of step 520, then the process terminates thereafter. If the computer determines that the solution automatically applied to the application in which the detected error occurred was unsuccessful in fixing the detected error, no output of step 520, then the computer notifies a user of the computer that the solution selected from the ranked list of solutions was unsuccessful in fixing the detected error (step 522). The computer then applies another solution from the ranked list of solutions to the application based on a different selection of another solution from the ranked list of solutions (step 524). Thereafter, the process terminates.

Thus, illustrative embodiments of the present invention provide a computer-implemented method, computer system, and computer program product for automatically applying a selected solution to resolve a detected software error on a computer system. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for resolving software errors, the computer-implemented method comprising:
detecting, by a computer, that an error corresponding to an application running on the computer has occurred;
determining, by the computer, a system configuration of the computer at a time of the error;
determining, by the computer, whether the error had previously occurred on one of the computer or at least one other computing system having a similar system configuration as the system configuration of the computer at the time of the error;
responsive to the computer determining that the error had previously occurred on one of the computer or the at least one other computing system having the similar system configuration as the system configuration of the computer at the time of the error, determining, by the computer, whether one or more solutions were found during a search that successfully fixed the error on one of the computer or the at least one other computing system having the similar system configuration as the system configuration of the computer at the time of the error; and
responsive to the computer determining that one or more solutions were found during the search that successfully fixed the error on one of the computer or the at least one other computing system having the similar system configuration as the system configuration of the computer at the time of the error, generating, by the computer, a list of solutions that successfully fixed the error corresponding to the application.

2. The computer-implemented method of claim 1, further comprising:
applying, by the computer, a solution automatically to the application in which the error occurred based on a selection of the solution from the list of solutions.

3. The computer-implemented method of claim 2, further comprising:
determining, by the computer, whether the solution automatically applied to the application in which the error occurred was successful in fixing the error;
responsive to the computer determining that the solution automatically applied to the application in which the error occurred was unsuccessful in fixing the error, notifying, by the computer, a user of the computer that the solution selected from the list of solutions was unsuccessful in fixing the error; and
applying, by the computer, another solution from the list of solutions to the application based on a different selection of another solution from the list of solutions.

4. The computer-implemented method of claim 1, further comprising:
responsive to the computer determining that one or more solutions to fix the error were not found during the search, generating, by the computer, an online request to other users who have encountered a same error as the error on their computing systems to upload a new solution; and
applying, by the computer, an online reward to a particular user who uploads the new solution to the error in response to the new solution successfully fixing the error in the application in which the error occurred.

5. The computer-implemented method of claim 1, further comprising:
ranking, by the computer, each respective solution in the list of solutions to form a ranked list of solutions based on a degree of system configuration similarity associated with a particular solution to the system configuration of the computer when the error occurred and a rate of success of each respective solution in the ranked list of solutions in fixing the error.

6. The computer-implemented method of claim 1, wherein the computer utilizes a system agent that runs once at each startup of the computer to collect information regarding a current system configuration of the computer.

7. The computer-implemented method of claim 1, wherein the computer utilizes a runtime agent that runs during operation of the computer to generate a log of all running applications, sequence in which applications were started and closed, currently open files along with their respective type and size, menu items selected by a user, and messages issued by an operating system of the computer, and wherein the computer utilizes the log to determine a set of interactions that caused the error.

8. A computer system for resolving software errors, the computer system comprising:
a communication fabric;
a storage device connected to the communication fabric, wherein the storage device stores program instructions; and
a processor connected to the communication fabric, wherein the processor executes the program instructions to:
detect that an error corresponding to an application running on the computer system has occurred;
determine a system configuration of the computer system at a time of the error;
determine whether the error had previously occurred on one of the computer system or at least one other computing system having a similar system configuration as the system configuration of the computer system at the time of the error;
determine whether one or more solutions were found during a search that successfully fixed the error on one of the computer system or the at least one other computing system having the similar system configuration as the system configuration of the computer system at the time of the error in response to determining that the error had previously occurred on one of the computer system or the at least one other computing system having the similar system configuration as the system configuration of the computer system at the time of the error; and
generate a list of solutions that successfully fixed the error corresponding to the application in response to determining that one or more solutions were found during the search that successfully fixed the error on one of the computer system or the at least one other computing system having the similar system configuration as the system configuration of the computer system at the time of the error.

9. The computer system of claim 8, wherein the processor further executes the program instructions to:
apply a solution automatically to the application in which the error occurred based on a selection of the solution from the list of solutions.

10. The computer system of claim 9, wherein the processor further executes the program instructions to:
determine whether the solution automatically applied to the application in which the error occurred was successful in fixing the error;
notify a user of the computer system that the solution selected from the list of solutions was unsuccessful in fixing the error in response to determining that the solution automatically applied to the application in which the error occurred was unsuccessful in fixing the error; and
apply another solution from the list of solutions to the application based on a different selection of another solution from the list of solutions.

11. The computer system of claim 8, wherein the processor further executes the program instructions to:
generate an online request to other users who have encountered a same error as the error on their computing systems to upload a new solution in response to determining that one or more solutions to fix the error were not found during the search; and
apply an online reward to a particular user who uploads the new solution to the error in response to the new solution successfully fixing the error in the application in which the error occurred.

12. The computer system of claim 8, wherein the processor further executes the program instructions to:
rank each respective solution in the list of solutions to form a ranked list of solutions based on a degree of system configuration similarly associated with a particular solution to the system configuration of the computer system when the error occurred and a rate of success of each respective solution in the ranked list of solutions in fixing the error.

13. The computer system of claim 8, wherein the computer system utilizes a system agent that runs once at each startup of the computer system to collect information regarding a current system configuration of the computer system.

14. A computer program product for resolving software errors, the computer program product comprising a computer-readable storage medium having program instructions embodied therewith, the program instructions executable by a computer to cause the computer to perform a method of:
detecting, by the computer, that an error corresponding to an application running on the computer has occurred;
determining, by the computer, a system configuration of the computer at a time of the error;
determining, by the computer, whether the error had previously occurred on one of the computer or at least one other computing system having a similar system configuration as the system configuration of the computer at the time of the error;
responsive to the computer determining that the error had previously occurred on one of the computer or the at least one other computing system having the similar system configuration as the system configuration of the computer at the time of the error, determining, by the computer, whether one or more solutions were found during a search that successfully fixed the error on one of the computer or the at least one other computing system having the similar system configuration as the system configuration of the computer at the time of the error; and
responsive to the computer determining that one or more solutions were found during the search that successfully fixed the error on one of the computer or the at least one other computing system having the similar system configuration as the system configuration of the computer at the time of the error, generating, by the computer, a list of solutions that successfully fixed the error corresponding to the application.

15. The computer program product of claim 14, further comprising:
applying, by the computer, a solution automatically to the application in which the error occurred based on a selection of the solution from the list of solutions.

16. The computer program product of claim 15, further comprising:
determining, by the computer, whether the solution automatically applied to the application in which the error occurred was successful in fixing the error;
responsive to the computer determining that the solution automatically applied to the application in which the error occurred was unsuccessful in fixing the error, notifying, by the computer, a user of the computer that the solution selected from the list of solutions was unsuccessful in fixing the error; and
applying, by the computer, another solution from the list of solutions to the application based on a different selection of another solution from the list of solutions.

17. The computer program product of claim 14, further comprising:
responsive to the computer determining that one or more solutions to fix the error were not found during the search, generating, by the computer, an online request to other users who have encountered a same error as the error on their computing systems to upload a new solution; and
applying, by the computer, an online reward to a particular user who uploads the new solution to the error in response to the new solution successfully fixing the error in the application in which the error occurred.

18. The computer program product of claim 14, further comprising:
ranking, by the computer, each respective solution in the list of solutions to form a ranked list of solutions based on a degree of system configuration similarly associated with a particular solution to the system configuration of the computer when the error occurred and a rate of success of each respective solution in the ranked list of solutions in fixing the error.

19. The computer program product of claim 14, wherein the computer utilizes a system agent that runs once at each startup of the computer to collect information regarding a current system configuration of the computer.

20. The computer program product of claim 14, wherein the computer utilizes a runtime agent that runs during operation of the computer to generate a log of all running applications, sequence in which applications were started and closed, currently open files along with their respective type and size, menu items selected by a user, and messages issued by an operating system of the computer, and wherein the computer utilizes the log to determine a set of interactions that caused the error.
